(19) United States
(12) Patent Application Publication
(10) Pub. No.: US 2006/0161770 A1
(43) Pub. Date: Jul. 20, 2006

(54) Network apparatus and program

(75) Inventors: Masataka Goto, Yokohama-shi (JP); Yoshihiko Kashio, Kawasaki-shi (JP); Masahiro Takagi, Toshima-ku (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Kabushiki Kaisha Toshiba, Minato-ku (JP)

(21) Appl. No.: 11/269,813

(22) Filed: Nov. 9, 2005

(30) Foreign Application Priority Data
Jan. 18, 2005 (JP) 2005-010079

(51) Int. Cl. H04L 9/00

(52) U.S. Cl. 713/167

(57) ABSTRACT

A wireless LAN communication system is composed of: a wireless LAN network including an AP 4 as one of the network apparatuses and a terminal 5 as one of the wireless terminals; and a wired network such as a LAN 1 to which the AP4, an authentication server 2, and other apparatus (such as a DHCP server 3) are connected.

### CROSS-REFERENCE TO RELATED APPLICATIONS

This application is based upon and claims the benefit of priority from the prior Japanese Patent Application No. 2005-10079, filed on Jan. 18, 2005; the entire contents of which are incorporated herein by reference.

### BACKGROUND

1. Field of the Invention

The present invention relates to a network apparatus such as an access point, a router, a bridge, a repeater, or a switching hub used in, for example, a wireless LAN and the like, and to a program.

2. Description of the Related Art

IEEE 802.1X is a communication protocol for user authentication in a data link layer among seven layers of the OSI reference model.

According to IEEE 802.1X, in a communication system in which an authenticator and a wireless terminal are connected to each other via a network apparatus such as an access point and a network such as LAN, the authenticator executes user authentication processing based on user authentication information such as a user ID and a password included in authentication request information that the authenticator receives from the terminal, thereby verifying if the MAC address of the terminal (apparatus) transmitting the user authentication information is authentic.

User IDs and passwords are most typically used as user authentication information in the current user authentication method, and a user is requested to input the user ID and the password not only at the time of the authentication when the user starts accessing a network, but also at many other occasions.

This poses a problem that the user feels it troublesome to input the user authentication information every time.

Meanwhile, a malicious-intentioned user is coming to use a more subtle technique for user imposture (impersonation), and therefore, the user authentication relying only on the user ID and the password has a limit.

Under such circumstances, there has been recently devised a user authentication technique which additionally employs the authentication of an IP address of a terminal (see, for example, Japanese Patent Laid-open Application No. 2002-84306).

### SUMMARY

However, the user authentication relying on the IP address cannot necessarily be said to be a safe way for confirming authenticity of a user utilizing a network because not only the IP address is automatically allocated (assigned) by a DHCP server, but also it can be assigned by a manual operation, which involves a possibility of illegal acts such as utilizing the network by, for example, ill-using the IP address that has already been authenticated.

The present invention was made to solve the problem described above, and an object thereof is to provide a network apparatus and a program with which soundness of communication can be checked with less trouble by a user.

A network apparatus according to an embodiment of the present invention is a network apparatus for communicating with an authenticator and other apparatus via a wired network and for communicating with a wireless terminal via a wireless network, comprising:

a memory configured to store terminal information of the wireless terminal which is authenticated by the authenticator based on authentication information sent from the wireless terminal, and configured to store a physical address of the wireless terminal associated with the terminal information; and

a check unit configured to determine whether an access from the wireless terminal is to be permitted or rejected, based on a set of the physical address and the terminal information acquired when the wireless terminal accesses the other apparatus and store at least one of the physical address and the terminal information to the memory.

A network apparatus according to another embodiment of the present invention is a network apparatus for communicating with an authenticator and other apparatus via a wired network and for communicating with a wireless terminal via a wireless network, comprising:

means for storing at least one of the terminal information of the wireless terminal which is authenticated by the authenticator based on authentication information sent from the wireless terminal, and a physical address of the wireless terminal associated with the terminal information; and

means for determining whether an access from the wireless terminal is to be permitted or rejected, based on a set of the physical address and the terminal information acquired when the wireless terminal accesses the other apparatus and storing at least one of the physical address and the terminal information to the means for storing.

A program according to an embodiment of the present invention is a program causes a network apparatus to perform as a apparatus for communicating with an authenticator and other apparatus via a wired network and for communicating with a wireless terminal via a wireless network, comprising:

a memory configured to store terminal information of the wireless terminal which is authenticated by the authenticator based on authentication information sent from the wireless terminal, and configured to store a physical address of the wireless terminal associated with the terminal information; and

a check unit configured to determine whether an access from the wireless terminal is to be permitted or rejected, based on a set of the physical address and the terminal information acquired when the wireless terminal accesses the other apparatus and store at least one of the physical address and the terminal information to the memory.

### BRIEF DESCRIPTION OF THE DRAWINGS

FIG. 1 is a diagram showing a wireless LAN communication system according to one embodiment of the present invention.

FIG. 2 is a view showing a MAC address-IP address management table stored in an AP.

FIG. 3 is a view showing a MAC address-locational information management table stored in the AP.

FIG. 4 is a communication sequence diagram showing operations when a terminal connects to a wireless LAN.

FIG. 5 is a communication sequence diagram showing IP address registration operations when a DHCP is used.

FIG. 6 is a communication sequence diagram showing IP address registration operations when an ARP is used.

FIG. 7 is a communication sequence diagram showing communication packet transfer processing.

FIG. 8 is a communication sequence diagram when location check results in “NG” determination.

FIG. 9 is a communication sequence diagram when IP address check processing results in “NG” determination.

FIG. 10 is a diagram showing a configuration of a wireless LAN communication system according to a second embodiment of the present invention.

### DETAILED DESCRIPTION

### Description of Embodiments

Embodiments of the present invention will be described with reference to the drawings, but these drawings are presented only for an illustrative purpose and in no way limit the present invention.

A network apparatus according to a first embodiment of the present invention, when receiving an access request from a wireless terminal, stores a physical address of the wireless terminal in a memory, and stores wireless terminal identifying information of the wireless terminal that the authenticator has authenticated based on authentication information, in the memory associated with the physical address, the wireless terminal identifying information being information, different from the physical address, for identifying a wireless terminal.

Then, when receiving, from the wireless terminal, an access request to other apparatus and acquiring the physical address and the wireless terminal identifying information of the wireless terminal, the network apparatus determines whether the access from the wireless terminal is to be permitted or rejected based on the relation between these acquired physical address and wireless terminal identifying information and the relation between the physical address and the wireless terminal identifying information previously stored in the memory.

In short, the network apparatus determines access permission or rejection based on the information, which is stored in the memory, consisting of the combination of the physical address automatically transmitted from the wireless terminal and information such as the wireless terminal identifying information (IP address and/or locational information) obtained in a different layer.

This configuration frees a user from the trouble of inputting user authentication information such as a user ID and a password at every access to the network.

Based on the above, the embodiments of the present invention will be hereinafter described in detail with reference to the drawings.

### First Embodiment

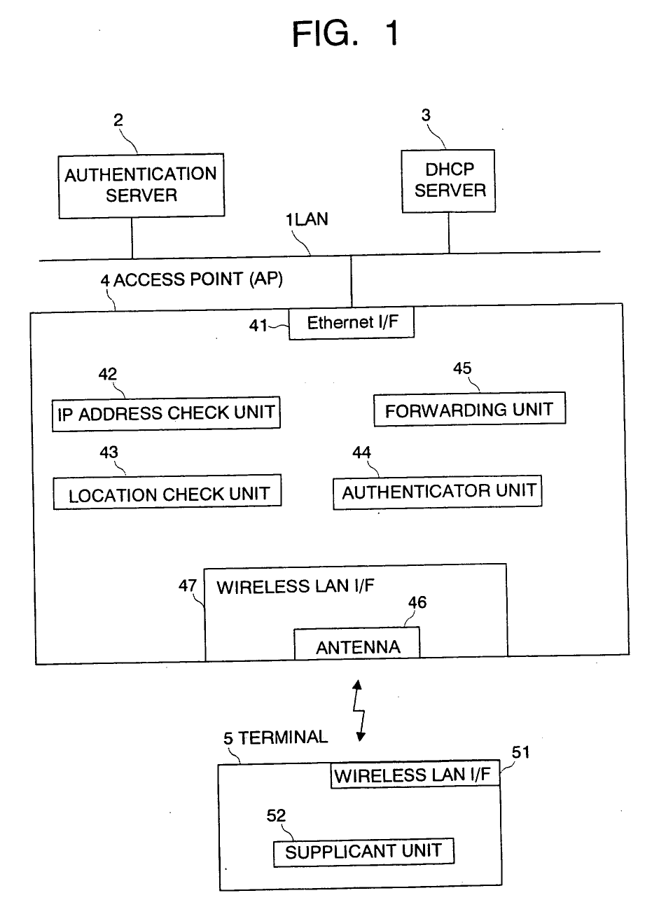

As shown in FIG. 1, a wireless LAN communication system of the first embodiment is composed of: a wireless LAN network including an access point 4 (hereinafter, referred to as AP 4) as one of the network apparatuses and a terminal 5 as one of the wireless terminals; and a wired network such as a local area network 1 (hereinafter, referred to as LAN 1) to which the AP 4, an authentication server 2, and other apparatuses (such as a DHCP server 3) are connected.

The AP 4 has an Ethernet interface 41 (hereinafter, referred to as Ethernet I/F 41) as a communication means on the wired network side, an IP address check unit 42, a location check unit 43, an authenticator unit 44 as an authentication means, a forwarding unit 45, an antenna 46, and a wireless LAN interface 47 (hereinafter, referred to as wireless LAN I/F 47) as a communication means on the wireless network side, and so on.

The AP 4 is connected to the authentication server 2 via the LAN 1, and is an apparatus through which the terminal 5 accesses the authentication server 2 and the DHCP server 3 on the LAN 1 by wireless communication.

Functions of the AP 4 are realized by hardware such as a CPU, a memory, a communication chip cooperatively operating with firmware or software such as an operating system.

Note that functions of the IP address check unit 42, the location check unit 43, the antenna 46, and so on are used when necessary, and all of these constituents are not necessarily essential.

When the AP 4 is provided with part of the above functions, only the relevant functions among individual functions to be hereinafter described can be realized.

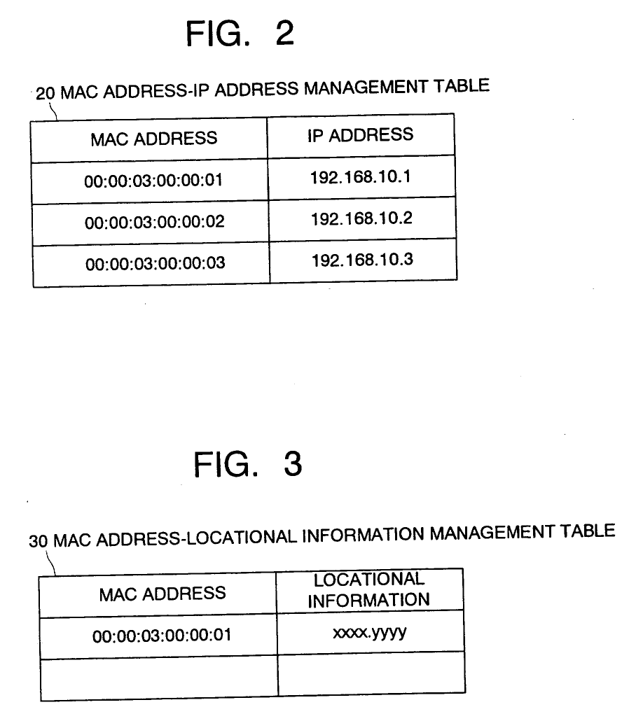

The IP address check unit 42 has a MAC address-IP address management table 20 (see FIG. 2) as an address storage means provided in the memory, and is provided with a check function of managing and checking the relation between IP addresses and MAC addresses based on this MAC address-IP address management table 20.

The IP address check unit 42 stores, in the MAC address-IP address management table 20, the MAC address of the terminal 5 included in authentication information which is sent from the terminal 5 when the terminal 5 accesses the authentication server 2.

The IP address check unit 42 checks the authenticity (consistency) of the IP address assigned to the terminal 5 by comparing the MAC address received from the terminal 5 and the MAC address stored in the MAC address-IP address management table 20.

The IP address check unit 42 stores the IP address whose authenticity has been confirmed by checking the MAC address, associate with the relevant MAC address stored in the MAC address-IP address management table 20.

When the terminal 5 which has been once authenticated accesses an apparatus (the DHCP server 3 or other apparatus) on the LAN 1, the IP address check unit 42 determines access permission or rejection based on the relation between the MAC address and the IP address stored in the MAC address-IP address management table 20.

The relation between the MAC address and the IP address refers to, for example, whether these addresses are associated to each other, whether only the MAC address is stored, and the like.

As shown in FIG. 2, the MAC address-IP address management table 20 is a MAC address/IP address relation storage part which holds the MAC addresses and the IP addresses of individual terminals associated with each other in such a manner that, for example, a MAC address (00:00:03:00:00:01) of a terminal and an IP address (192.168.10.1) are associated to each other, a MAC address (00:00:03:00:00:02) and an IP address (192.168.10.2) are associated to each other, and a MAC address (00:00:03:00:00:03) and an IP address (192.168.10.3) are associated to each other.

In short, the IP address check unit 42 holds pairs (sets) of the MAC address and the IP address in the memory as a table at the time of the authentication, and every time an access request to the other apparatus takes place thereafter, it determines whether a pair (set) of the MAC address and the IP address currently acquired matches the information stored in the memory, thereby verifying the authenticity of the communication.

The location check unit 43 has a MAC address-locational information management table 30 (see FIG. 3) as a location/address storage means provided in the memory, and is provided with a check function of managing and checking the relation between locational information and the MAC address of the terminal 5 under communication, based on the MAC address-locational information management table 30.

The location check unit 43 stores the locational information, which is acquired by the antenna 46 and the wireless LAN I/F 47, and the MAC address of the terminal 5 included in the authentication information which is received when the terminal 5 accesses the authentication server 2, the locational information and the MAC address being stored in the MAC address-locational information management table 30 associated with each other.

When the terminal 5 having been once authenticated accesses an apparatus on the LAN 1, the location check unit 43 determines access permission or rejection based on the MAC address stored in the MAC address-locational information management table 30 and the acquired locational information.

As shown in FIG. 3, the MAC address-locational information management table 30 is a MAC address/locational information relation storage part which holds the MAC addresses and the locational information of the terminals associated with each other in such a manner that, for example, a MAC address (00:00:03:00:00) and locational information (an X coordinate (xxxx), a Y coordinate) yyyy)) are associated to each other.

In short, the location check unit 43 holds a pair (set) of the MAC address and the locational information of the terminal 5 in the memory as a table at the time of the authentication, and every time an access request to the other apparatus takes place thereafter, it determines whether a pair (set) of the MAC address and the locational information of the terminal 5 currently acquired matches the information stored in the memory, thereby verifying the authentication of the communication.

The forwarding unit 45 is a function of transmitting a communication packet, which is received at one of the communication interfaces, via the other communication interface, and it acquires the MAC address, the IP address, the locational information, and so on from the communication packet when executing transfer processing of the communication packet, and notifies the acquired information to the IP address check unit 42 and the location check unit 43 so that these pieces of information are stored in the respective tables.

As for the forwarding unit 45, there are some having a packet transfer function including a procedure for avoiding double transfer of a communication packet caused by a plurality of transfers, a procedure for avoiding a loop, and the like, but these procedures may be realized by using other function.

The authenticator unit 44 is a constituent element of an authentication function for security purpose such as IEEE 802.1X authentication, IEEE 802.11i, or Wi-Fi Protected Access (WPA). The authenticator unit 44 authenticates the terminal 5, which gives the AP 4 a connection request to the LAN 1, through the use of secret information of a user stored in advance in the memory based on encryption information received from the terminal 5.

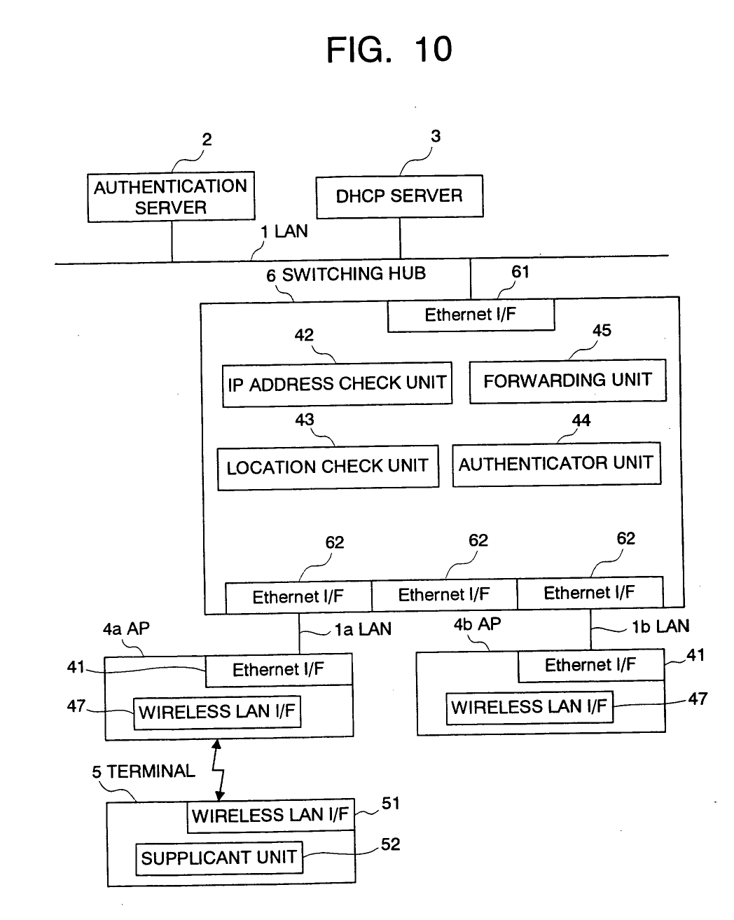

In the wireless LAN communication system of the first embodiment shown in FIG. 1 and a wireless LAN communication system of a second embodiment shown in FIG. 10, IEEE 802.1X and an authentication procedure in conformity thereto are assumed as the authentication procedure, and the authentication is executed by the handshake among three parties, namely, a supplicant unit 52 of the terminal 5, the authenticator unit 44 of the AP 4, and the authentication server 2.

In this case, upon receiving an acceptance message from the authentication server 2 at the end of the authentication procedure, the authenticator unit 44 of the AP 4 accepts the connection request of the terminal 5 to start its communication with the terminal 5.

An authentication method in the authenticator unit 44 is not limited to the above-described authentication procedure, but the essential point in authenticating a terminal similar to the terminal 5 is to accept the connection based on the final authentication result.

In addition to the function of determining the acceptance/rejection of the connection of the terminal through the above-described user authentication processing, the AP 4 has, in its memory, address management tables such as the MAC address-IP address management table 20 and the MAC address-locational information management table 30.

The IP address check unit 42 or the location check unit 43 stores the MAC address, IP address, and locational information, which are acquired from the communication packet transferred thereto, in each of the tables and manages them.

As the antenna 46, used is, for example, a smart antenna or the like having a plurality of non-directional antennas arranged in arrays.

By processing signals received by the respective non-directional antennas, it is possible to estimate the direction of an incoming wave and acquire the locational information of the terminal under communication.

The signal processing utilizes a known incoming wave estimation technique such as, for example, a MUSIC (Multiple Signal Classification) method, an ESPRIT (Estimation of Signal Parameters via Rotational Invariance Techniques) method.

The antenna 46 and the wireless LAN I/F 47 function as a locational information acquisition part which acquires the locational information of the terminal 5 based on the incoming direction of the wave received from the terminal 5.

The terminal 5 includes a wireless LAN I/F 51 and the supplicant unit 52.

The wireless LAN I/F 51 is an apparatus performing communication via the wireless LAN according to IP.

The supplicant unit 52 executes the user authentication in cooperation with the authentication server 2 and the authenticator unit 44 of the AP 4.

Concrete examples of the terminal 5 are typically, for example, a personal computer (PC), a personal digital assistance (PDA), and the like.

The PDA, which is a portable information terminal for personal use, is an electronic device small enough to be held in a hand and having some of the functions that the PC possesses.

The PDA has a connection terminal to a liquid crystal device or an external part and is driven by a battery or a dedicated battery. Intended uses and functions of the terminal 5 are not limited to specific ones.

In the description below, it is assumed that the MAC address of the wireless LAN I/F 51 of the terminal 5 is 00:00:39:01:02:03.

The authentication server 2 is an authenticator which executes the user authentication in cooperation with the authenticator unit 44 of the AP 4 and the supplicant unit 52 of the terminal 5 based on the authentication information sent from the terminal 5.

As the authentication server 2, for example, a RADIUS server or the like is used, but other server may be used as long as it has the authentication function.

The DHCP server 3 is a server implemented with a DHCP (Dynamic Host Configuration Protocol) that automatically allocates the IP address (IP address automatic assignment) to the terminal 5 transmitting an address assignment request (a DHCP request) and notifies network setting information relating to this.

Incidentally, the IP address of the terminal 5 can be also assigned by key input from an address setting window of the terminal 5.

Hereinafter, operations of this wireless LAN communication system will be described.

The operations of the wireless LAN communication system include operations when the terminal 5 connects to the wireless LAN, operations when the IP address of the terminal 5 is set, operations while the terminal 5 is under data communication, and so on, and each of the operations will be described.

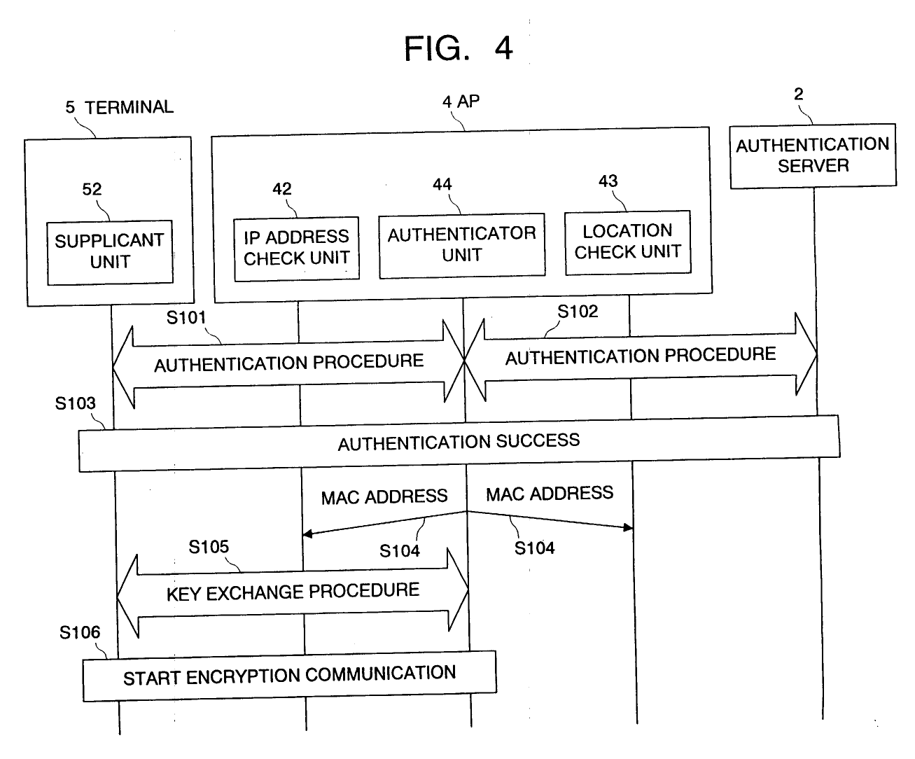

First, the operations when the terminal 5 connects to the wireless LAN will be described with reference to FIG. 4.

At the time of the connection to the wireless LAN, the supplicant unit 52 of the terminal 5, the authenticator unit 44 of the AP 4, and the authentication server 2 execute the authentication procedure in cooperation (S101, S102).

In the authentication procedure, the terminal 5 transmits information including at least the MAC address of the terminal 5 and this transmission information is transferred to the authentication server 2 via the AP 4.

Then, when the authentication by the three parties succeeds (S103), the authenticator unit 44 notifies the IP address check unit 42 and the location check unit 43 of the MAC address, which is a physical address of the terminal 5, acquired from the terminal 5 at the time of the authentication (S104).

Then, a key exchange procedure between the authenticator unit 44 and the supplicant unit 52 is executed (S105) to generate an encryption key. Thereafter, encryption communication is started between the wireless LAN I/F 51 of the terminal 5 and the antenna 46 of the AP 4 (S106).

That is, during a period between the authentication success and the key exchange procedure, the authenticator unit 44 takes out (extracts) the MAC address of the terminal 5 from the communication packet transferred by the forwarding unit 45 to notify the MAC address to the IP address check unit 42 and the location check unit 43.

The notification of the MAC address includes the MAC address 00:00:39:01:02:03 of this terminal 5.

Incidentally, when one of the IP address check unit 42 and the location check unit 43 is not provided in the AP 4 because of reasons in terms of the functional configuration of the AP 4, the authenticator unit 44 notifies the MAC address only to the provided unit.

At an instant when the MAC address is notified from the authenticator unit 44 to the IP address check unit 42, information on the IP address related to this MAC address is not held in the MAC address-IP address management table 20.

Therefore, the MAC address-IP address management table 20 only has as its information the MAC address, 00:00:39:01:02:03, which is entered to a MAC address field, and an IP address field of the MAC address-IP address management table 20 is left blank until the relating IP address is notified.

Similarly, the location check unit 43, upon notified of the MAC address, stores the MAC address in the MAC address-locational information management table 30 which holds the relation between the MAC address and the locational information.

At this instant, however, since the locational information of the terminal 5 with this MAC address has not been received yet, the MAC address-locational information management table 30 only has the MAC address, 00:00:39:01:02:03, which is entered in a MAC address field, and a locational information field is left blank.

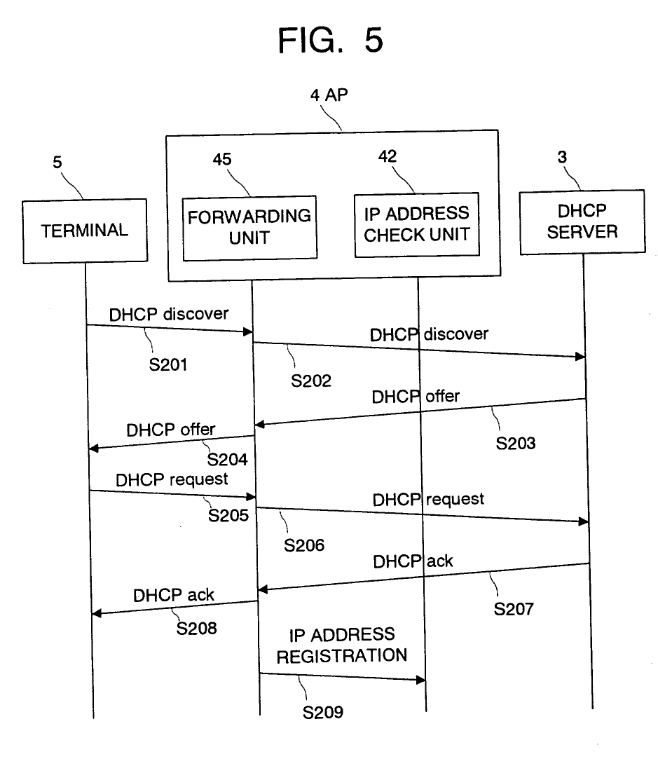

Next, the operations when the IP address of the terminal 5 is set will be described with reference to FIG. 5.

When the IP address of the terminal 5 is set utilizing the DHCP function on the LAN 1, the terminal 5 transmits a request for confirming whether or not the DHCP function exists on the LAN 1 (DHCP discover) via the AP 4 to the DHCP server 3 on the LAN 1 (S201, S202).

The DHCP server 3, upon receiving the request (DHCP discover) from the terminal 5, sends back a notification (DHCP offer) for offering the DHCP function to the transmitting-end terminal 5 (S203, S204).

The terminal 5 receiving the notification (DHCP offer) from the DHCP server 3 transmits an IP address setting request (DHCP request) via the AP 4 to the DHCP server 3 on the LAN 1 (S205, S206).

The DHCP server 3, upon receiving the IP address setting request (DHCP request) from the terminal 5, utilizes its DHCP function to dynamically allocate to the terminal 5 the IP address not currently in use out of IP addresses that it possesses, and it sends back a message (DHCP ack) to that effect to the terminal 5 (S207, S208).

In this manner, the terminal 5 receives via the AP 4 the IP address, which is assigned to itself by the DHCP server 3 on the LAN 1 according to the DHCP procedure through the intermediation of the AP 4, and the notification of the network setting related to this.

At this time, in the AP 4, the forwarding unit 45, after forwarding the final message (DHCP ask) of the DHCP to the terminal 5, notifies an IP address registration message regarding the terminal 5 to the IP address check unit 42 (S209).

The IP address registration message includes the MAC address of the terminal 5 and the IP address assigned to the terminal 5.

Assuming that the IP address assigned by the DHCP server 3 is, for example, 192.169.0.1, the IP address registration message includes 00:00:39:01:02:03 as the MAC address and 192.169.0.1 as the IP address.

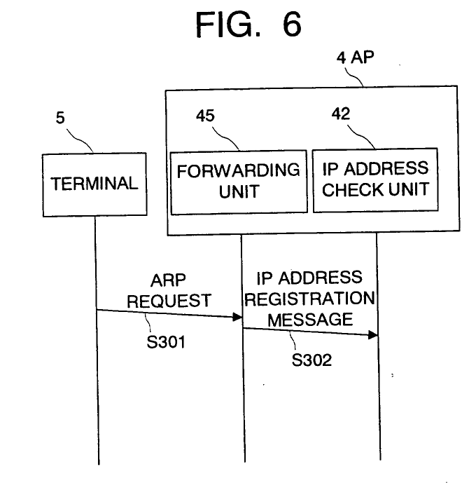

Here, IP address registration operations when an address resolution protocol (hereinafter, referred to as ARP) is used will be described with reference to FIG. 6.

When the IP address of the terminal 5 is set by the aforesaid IP address setting operation, the terminal 5 transmits an ARP request (S301).

At this time, the forwarding unit 45 of the AP 4, after transferring to the LAN 1 the ARP request received from the terminal 5, notifies an IP address registration message regarding the terminal 5 to the IP address check unit 42 (S302).

Incidentally, the IP address registration operations may be one of the operations using the DHCP and the operations using the ARP, or the operations using the both.

The IP address check unit 42 receiving the IP address registration message compares the IP address of the terminal 5 included in the message with the information in the MAC address-IP address management table 20 to confirm whether there is no inconsistency between the information on the terminal 5 received at this moment and the information in the table.

Thereafter, the IP address check unit 42 stores the IP address included in the message associated with the MAC address of this terminal 5.

Note that the inconsistency at this moment means that the relation of this IP address has been already established with a different MAC address.

Alternatively, the determination that inconsistency exists may be made if the relation of this MAC address has been already established with a different IP address by the setting of a manager.

This means that the setting of a plurality of IP addresses to one terminal is not allowed.

By the IP address registration operations, the IP address 192.169.0.1 is stored associate with the MAC address 00:00:39:01:02:03 in the MAC address-IP address management table 20.

Further, if the setting by the manager permits the setting of the plural IP addresses to the single terminal 5, the plural IP addresses (such as the first IP address 192.169.0.1 and the second IP address 192.169.0.101) are stored associate with the single MAC address 00:00:39:01:02:03.

The relation between the MAC address and the IP address in the MAC address-IP address management table 20 is cancelled when the terminal 5 with this MAC address terminates the connection to the wireless LAN.

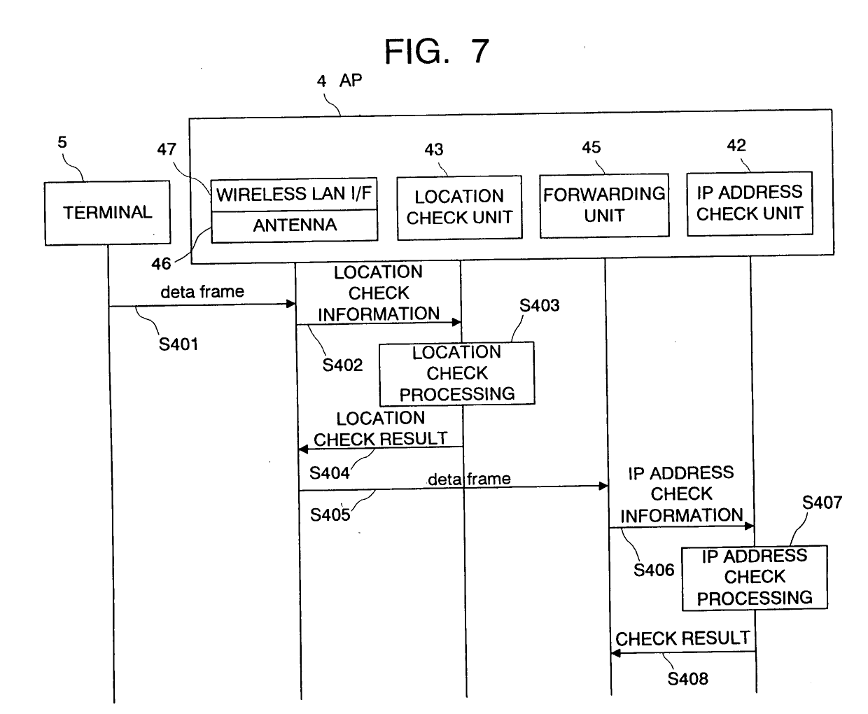

Next, the operations while the terminal 5 is under data communication will be described with reference to FIG. 7.

As shown in FIG. 7, the terminal 5 transmits a data frame by wireless communication (S401), and when the data frame is received by the antenna 46 and the wireless LAN I/F 47 of the AP 4, the forwarding unit 45 transfers the received data frame to the LAN 1 via the Ethernet I/F 41.

While thus transferring the communication packet, the forwarding unit 45 sends location check information to the location check unit 43 in order to confirm authenticity of the location of the transmitting-end terminal found by the antenna 46 regarding the data frame received by the wireless LAN I/F 47 (S402).

The location check information includes the MAC address of the terminal 5, which is a check target terminal, and the locational information of the check target terminal 5.

The forwarding unit 45 acquires the MAC address of the terminal 5 from header information included in the data frame.

The forwarding unit 45 acquires the locational information of the terminal 5 through the incoming wave estimation function of the antenna 46.

A method of the incoming wave estimation may be any of the aforesaid known techniques (the MUSIC method, the ESPRIT method, and the like), but the locational information has to be converted to numerical values by a method of some kind or other.

The location check unit 43 receiving the location check information stores the locational information in the MAC address-locational information management table 30 if the locational information field for the relevant MAC address in the MAC address-locational information management table 30 is blank.

If the locational information related to the relevant MAC address in the MAC address-locational information management table 30 already exists, that is, it is held, the location check unit 43 checks the authenticity of the received locational information (S403).

A method of checking the authenticity of the locational information is set by the manager, and for example, if it is preconditioned that the terminal 5 does not move, the location check unit 43 determines the locational information as inauthentic when the current locational information is different from that at the authentication time.

If it is preconditioned that the terminal 5 moves to some extent, the location check unit 43 determines that the locational information is inauthentic when a difference between the locational information in the MAC address-locational information management table 30 and the locational information currently checked is equal to or larger than a threshold value which is set in advance in itself.

A determining method when it is preconditioned that the terminal 5 moves at a certain speed is such that, for example, the location check unit 43 checks the difference between the locational information in the MAC address-locational information management table 30 and the locational information at the time of the check while updating the locational information in the MAC address-locational information management table 30 to the current locational information every time, and determines the locational information as inauthentic when the difference is equal to or larger than the threshold value set in itself in advance. These methods may be used in combination.

The location check unit 43, after finishing the check, sends back the MAC address and an “OK/NG” result of the location check (S404).

When the location check result is “OK” or when the location check unit 43 is not provided, the data frame is sent to the forwarding unit 45 (S405).

When the location check result is “OK”, the forwarding unit 45 sends IP address check information to the IP address check unit 42 (S406).

The IP address check information includes the MAC address and the IP address of the transmitting-end terminal 5 included in this data frame.

The IP address check unit 42 receiving the IP address check information refers to the MAC address-IP address management table 20 to recognize the IP address for the relevant MAC address and performs IP address check processing (S407).

In this check processing, the IP address is determined as inauthentic when an IP address field in the MAC address-IP address management table 20 is blank and the IP addresses acquired from the MAC address-IP address management table 20 do not include the IP address included in the IP address check information.

The IP address check unit 42 having finished the IP address check processing sends back the check result (S408).

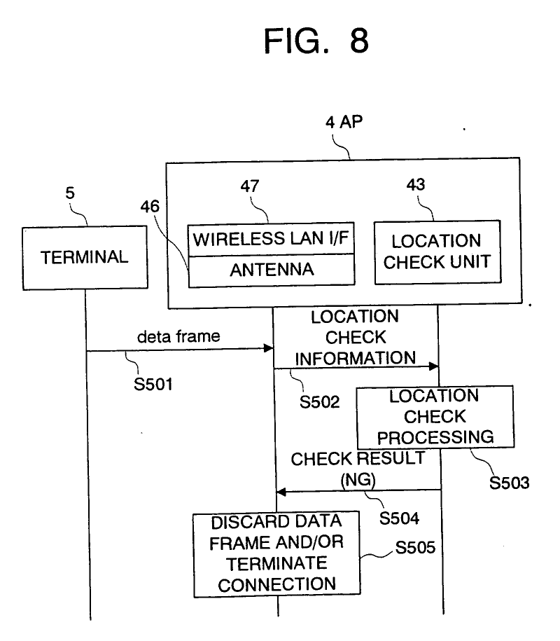

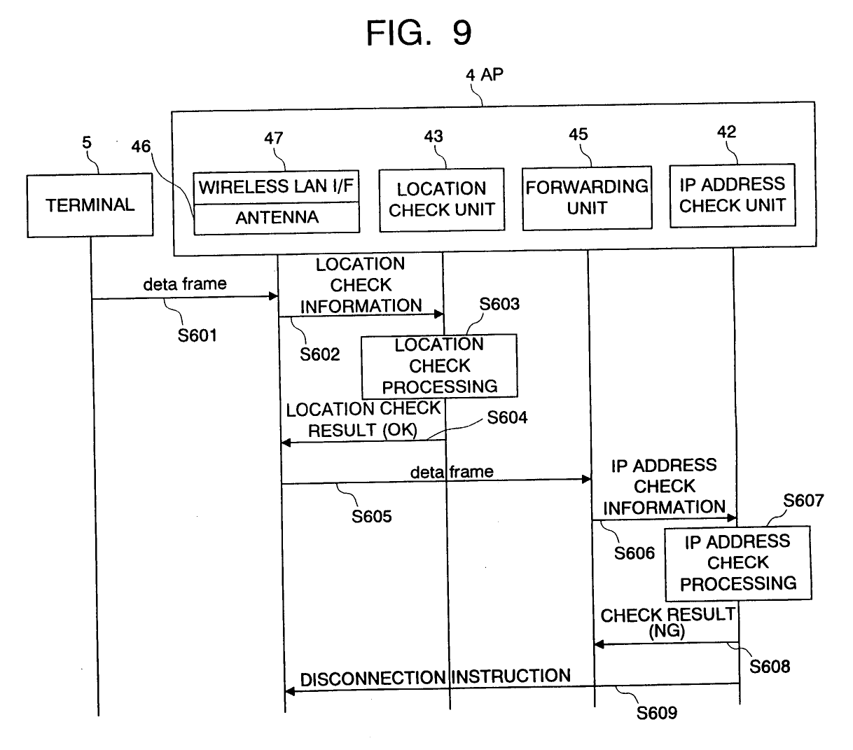

Referring to FIG. 8 and FIG. 9, the next description will be on a case where the IP address check unit 42 or the location check unit 43 determines that the information received from the terminal 5 is inauthentic as a result of checking the information on the terminal 5.

As shown in FIG. 8, when the data frame transmitted from the terminal 5 is received by the antenna 46 and the wireless LAN I/F 47 of the AP 4 (S501), the information used for checking the location (hereinafter, referred to as location check information), included in the received data is sent to the location check unit 43 (S502).

The location check information includes the MAC address of the terminal 5 being a check target terminal and the locational information of the terminal 5 at the time of the check.

The location check unit 43 searches the MAC address-locational information management table 30 based on the location check information to check “OK/NG” of the location of the terminal 5 at this moment (S503), and sends back to the wireless LAN I/F 47 the location check result including “NG” information (S504).

The wireless LAN I/F 47 receiving “NG” as the location check result either discards the relevant data frame or terminates the connection with the relevant terminal 5, or performs the both operations (S505).

As shown in FIG. 9, when the data frame is wirelessly transmitted from the terminal 5 (S601) to be received by the antenna 46 and the wireless LAN I/F 47 of the AP 4, the forwarding unit 45 transfers the received data frame to the LAN 1 via the Ethernet I/F 41.

As described above, while transferring the communication packet, the forwarding unit 45 transmits the location check information to the location check unit 43 in order to confirm the authenticity of the transmitting-end terminal's location found by the antenna 46 regarding the data frame received by the wireless LAN I/F 47 (S602).

The location check information includes the MAC address of the terminal 5 being the check target terminal and the locational information of the terminal 5 at the current moment. The forwarding unit 45 acquires the MAC address of the terminal 5 from the header information included in the data frame.

The forwarding unit 45 acquires the locational information of the terminal 5 through the incoming wave estimation function of the antenna 46.

The location check unit 43 receiving the location check information stores this locational information in the MAC address-locational information management table 30 if the locational information field related to the relevant MAC address in the MAC address locational information management table 30 is blank.

If the locational information related to the relevant MAC address exists, that is, it is held, in the MAC address-locational information management table 30, the location check unit 43 checks “OK/NG” of the locational information (S603).

The method of checking “OK/NG” of the locational information is shown in the description of FIG. 7, and therefore the description thereof will be omitted here.

After the check, the location check unit 43 sends back the location check result including the MAC address and the “OK/NG” result of the location check (S604).

When the location check result is “OK”, or when the location check unit 43 is not provided, the data frame is sent to the forwarding unit 45 (S605).

When the location check result is “OK”, the forwarding unit 45 sends the IP address check information to the IP address check unit 42 (S606).

The IP address check information includes the MAC address and the IP address of the transmitting-end terminal 5 which are included in the data frame.

The IP address check unit 42 receiving the IP address check information refers to the MAC address-IP address management table 20 to recognize the IP address related to the relevant MAC address and executes the IP address check processing (S607).

In this check processing, it is determined that inconsistency exists if an IP address field related to the relevant MAC address in the MAC address-IP address management table 20 is blank and the IP addresses acquired from the MAC address-IP address management table 20 do not include the IP address included in the IP address check information.

In this case, the IP address check unit 42 having finished the IP address check processing sends back “NG” to the forwarding unit 45 as the check result (S608).

Then, the forwarding unit 45 receiving “NG” as the check result discards the data frame, or the IP address check unit 42 sends to the wireless LAN I/F 47 a disconnection instruction (including the MAC address of the terminal 5) for terminating the connection with the terminal 5, or the both operations are performed (S609).

As described above, according to the wireless LAN communication system of the first embodiment, the AP 4 having the user authentication function and the transfer function holds a trustworthy terminal identifier (MAC address) acquired at the time of the user authentication, and based on this terminal identifier, it checks at least one of the locational information of the terminal 5 and the terminal identifier of an upper protocol layer (IP address). This frees a user from the trouble of inputting the user ID, the password, and the like for user authentication and makes it possible to check the soundness of communication with less trouble by the user.

Further, the IEEE 802.1X user authentication in the link layer of the OSI reference model is adopted for the confirmation, so that it is possible to check the soundness of communication based on the consistency of ARP, the consistency of an IP header and a MAC header, and the consistency of the locational information acquired from the antenna 46 and the MAC header.

In short, in this wireless LAN communication system, it is possible not only to check the soundness of communication with less trouble by a user but also to prevent an unauthorized access to the network with the use of a deceptive IP address. Therefore, communication with high security is realized.

It should be noted that the present invention is not limited only to the embodiment described above.

In the first embodiment described above, the AP 4 of the wireless LAN communication system has the major functions, but hardware other than the AP may have these functions.

Specifically, as shown in FIG. 10, the wireless LAN communication system of the second embodiment is configured such that an AP 4a is connected via a LAN 1a to a switching hub 6 connected to the LAN 1, and an AP 4b is connected via a LAN 1b to the switching hub 6.

In this wireless LAN communication system, the switching hub 6 is provided with an Ethernet I/F 61 as a communication function on a wired side, an IP address check unit 42, a location check unit 43, an authenticator unit 44 as an authentication function, a forwarding unit 45, Ethernet I/Fs 62 as a function of communicating with the individual APs, and so on.

In the above configuration, the switching hub 6 performs the same operations as those in the first embodiment described above.

When a check target terminal is a wireless terminal as in the first embodiment, the incoming wave estimation can be utilized for acquiring the locational information of the check target terminal 5, but in the second embodiment, a target terminal for location check by the switching hub 6 is a terminal locationed ahead of the terminals such as the APs 4a, 4b connected to the switching hub 6 via wired networks.

In this case, the locational information is replaced by information regarding which one of the plural Ethernet I/Fs 62 provided in the switching hub 6 receives a communication packet, and the location of the terminal is identified based on identification information set in the individual Ethernet I/F 62.

### Other Embodiments

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A network apparatus for communicating with an authenticator and other apparatus via a wired network and for communicating with a wireless terminal via a wireless network, comprising:
a memory configured to store terminal information of the wireless terminal which is authenticated by the authenticator based on authentication information sent from the wireless terminal, and configured to store a physical address of the wireless terminal associated with the terminal information; and
a check unit configured to determine whether an access from the wireless terminal is to be permitted or rejected, based on a set of the physical address and the terminal information acquired when the wireless terminal accesses the other apparatus and store at least one of the physical address and the terminal information to the memory.

2. The network apparatus according to claim 1,
wherein the terminal information is an IP address of the wireless terminal which is authenticated by the authenticator based on the authentication information.

3. The network apparatus according to claim 2,
wherein the IP address is included in the authentication information based on which the authenticator authenticates the wireless terminal.

4. The network apparatus according to claim 2,
wherein the IP address is an address allocated by other apparatus implemented with a dynamic host configuration protocol.

5. The network apparatus according to claim 2,
wherein the IP address is an address resolved by an address resolution protocol.

6. The network apparatus according to claim 1,
wherein said memory stores the physical address and the IP address associated with each other, and
wherein said check unit determines whether the access from the wireless terminal is to be permitted or rejected by comparing the IP address of the wireless terminal acquired when the wireless terminal accesses the other apparatus with the IP address stored in said memory.

7. The network apparatus according to claim 1,
wherein the terminal information is locational information of the wireless terminal acquired when the authenticator authenticates the wireless terminal based on the authentication information.

8. The network apparatus according to claim 1, further comprising:
a locational information acquisition part acquiring locational information of the wireless terminal,
wherein said check unit registers the locational information, which is acquired by said locational information acquisition part, of the wireless terminal authenticated by the authenticator based on the authentication information, in said memory associated with the physical address.

9. The network apparatus according to claim 8,
wherein said locational information acquisition part acquires the locational information of the wireless terminal based on an incoming direction of a wave received from the wireless terminal.

10. The network apparatus according to claim 1,
wherein said memory stores the physical address and the locational information associated with each other, and
wherein said check unit determines whether the access from the wireless terminal is to be permitted or rejected by collating the locational information of the wireless terminal acquired when the wireless terminal accesses the other apparatus with the locational information stored in said memory.

11. The network apparatus according to claim 1,
wherein the wireless terminal identifying information is an IP address and locational information of the wireless terminal which is authenticated by the authenticator based on the authentication information.

12. The network apparatus according to claim 11,
wherein the IP address is included in the authentication information based on which the authenticator authenticates the wireless terminal.

13. The network apparatus according to claim 1,
wherein said memory stores the physical address and the IP address associated with each other, and
wherein said check unit determines whether the access from the wireless terminal is to be permitted or rejected by collating the IP address and the locational information of the wireless terminal acquired when the wireless terminal accesses the other apparatus with the IP address and the locational information stored in said memory.

14. A network apparatus for communicating with an authenticator and other apparatus via a wired network and for communicating with a wireless terminal via a wireless network, comprising:
means for storing at least one of the terminal information of the wireless terminal which is authenticated by the authenticator based on authentication information sent from the wireless terminal, and a physical address of the wireless terminal associated with the terminal information; and
means for determining whether an access from the wireless terminal is to be permitted or rejected, based on a set of the physical address and the terminal information acquired when the wireless terminal accesses the other apparatus and storing at least one of the physical address and the terminal information to the means for storing.

15. A program causes a network apparatus to perform as a apparatus for communicating with an authenticator and other apparatus via a wired network and for communicating with a wireless terminal via a wireless network, comprising:
a memory configured to store terminal information of the wireless terminal which is authenticated by the authenticator based on authentication information sent from the wireless terminal, and configured to store a physical address of the wireless terminal associated with the terminal information; and
a check unit configured to determine whether an access from the wireless terminal is to be permitted or rejected, based on a set of the physical address and the terminal information acquired when the wireless terminal accesses the other apparatus and store at least one of the physical address and the terminal information to the memory.
